(19) United States
(12) Patent Application Publication
(10) Pub. No.: US 2008/0124508 A1
(43) Pub. Date: May 29, 2008

(54) Method For Producing Refractive Index Profile Plastic Optical Device

(75) Inventor: Masataka Sato, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/791,925

(22) PCT Filed: Dec. 15, 2005
(86) PCT No.: PCT/JP05/23442

§ 371 Date: May 31, 2007

(30) Foreign Application Priority Data
Dec. 15, 2004 (JP) 2004-362310

(51) Int. Cl. G02B 6/028; G02B 6/00

(52) U.S. Cl. 428/38; 264/1.24; 264/1.29

(57) ABSTRACT

A method for producing a plastic optical device having refractive index profile, which comprises filling the hollow of a hollow plastic structure with at least one non-polymerizable compound having a refractive index higher by at least 0.001 than that of the plastic structure, and diffusing the non-polymerizable compound into the plastic structure. The method gives a plastic optical device having refractive index profile free from a problem of loss increase owing to thermal deterioration or depolymerization.

### TECHNICAL FIELD

The present invention relates to a plastic optical device having refractive index profile. Concretely, it relates to a method for producing a plastic optical device having refractive index profile that contributes to the quality improvement of plastic light waveguide having refractive index profile.

### BACKGROUND ART

Heretofore, various investigations have been made for the production of plastic optical devices having refractive index profile. For example, the following methods are disclosed: A cylindrical tube of a polymer is filled with a mixture comprising a monomer, a polymerizable refractive index control agent and a polymerization initiator, and subjected to thermal polymerization to form a core therein, and the polymer tube is thereby made to have a refractive index profile owing to the concentration profile of the refractive index control agent in the core (WO93/08488); a laminate of two or more polymerizable mixtures that differ in point of the refractive index profile thereof are concentrically extruded to form a plastic optical device having refractive index profile (JP-A 2-16504); into the center of a melt of an amorphous fluoropolymer (a) substantially not having a C—H bond, diffused is at least one substance (b) of which the refractive index differs from that of the fluoropolymer (a) by at least 0.001, or a relatively high-concentration substance (c) is kept adjacent to the fluoropolymer (a) and the substance (c) is thermally diffused into it with rotary shaping (JP-A 8-5848, 8-334633); and in polymer blends, the blend ratio of the constitutive polymers that differ in point of the refractive index thereof is continuously changed (JP-A 6-297596).

However, in an interfacial gel polymerization method, the monomer reaction and the dopant diffusion occur simultaneously, and therefore, the method has some problems in that bubbles may come in the system owing to the polymerization shrinkage to give a polymer, the remaining monomer may be difficult to remove and the method is not applicable to poorly-reactive monomers.

On the other hand, in a method of melt diffusion, the dopant diffusion follows a Fickian diffusion equation, and therefore, it is difficult to realize an ideal refractive index profile throughout the overall region of a core according to the method. Specifically, in the method, the interfacial distribution between the core and the clad is gentle and the high-order mode diffusion is great. Further, in the method of melt diffusion, the dopant must be diffused at a high temperature, therefore causing a risk of thermal deterioration, and the equipment for evading the problem will be expensive.

### DISCLOSURE OF THE INVENTION

The invention is to solve the above-mentioned problems, and it provides a method for producing a plastic optical device having refractive index profile with no trouble of loss increase owing to thermal deterioration or depolymerization.

Having the technical theme as above, we, the present inventors have assiduously studied and, as a result, have found that, when the hollow of a hollow plastic structure is filled with a non-polymerizable compound and heated, then it gives a plastic optical device having refractive index profile. Concretely, we have solved the problems according to the method mentioned below.

(1) A method for producing a plastic optical device having refractive index profile, which comprises filling the hollow of a hollow plastic structure with at least one non-polymerizable compound having a refractive index higher by at least 0.001 than that of the plastic structure, and diffusing the non-polymerizable compound into the plastic structure.

(2) The method for producing a plastic optical device having refractive index profile of (1), wherein the non-polymerizable compound is thermally diffused within a temperature range (Td) satisfying the condition of the following equation (1) relative to the glass transition temperature (Tg) of the plastic structure:

Tg−35≦Td≦Tg+70. (1)

(3) The method for producing a plastic optical device having refractive index profile of (1) or (2), wherein the diffusion is attained with rotating the plastic structure.

(4) The method for producing a plastic optical device having refractive index profile of (1) or (2), wherein the diffusion is attained with keeping the plastic structure vertical in a static state.

(5) The method for producing a plastic optical device having refractive index profile of any one of (1) to (4), wherein the plastic structure is cylindrical, and the plastic optical device having refractive index profile approximates to the following equation (2) in which R indicates the radius of the cross section up to the diffusion interface of the non-polymerizable compound filled in the hollow of the plastic structure, N¹ indicates the refractive index of the non-polymerizable compound before diffusion, N² indicates the refractive index of the plastic structure before filled with the non-polymerizable compound, N(r) indicates the refractive index at a distance r from the center of the cross section of the plastic structure after filled with the non-polymerizable compound, and g indicates a refractive index profile coefficient:

N(r)=N¹(1−(r/R)^{g}×Δ) (2)

wherein Δ=(N¹−N²)/N¹.

(6) The method for producing a plastic optical device having refractive index profile of any one of (1) to (5), wherein the non-polymerizable compound is liquid or solid at 25° C. and the non-polymerizable compound is filled into the hollow to a volume smaller than the capacity of the hollow.

(7) The method for producing a plastic optical device having refractive index profile of any one of (1) to (5), wherein the non-polymerizable compound is a compound liquid at 25° C. and the compound is filled into the hollow entirely with no space remaining therein.

(8) The method for producing a plastic optical device having refractive index profile of any one of (1) to (7), wherein the plastic structure is a polymer that swells through penetration of the non-polymerizable compound thereinto, and the non-polymerizable compound is diffused owing to the penetration of the compound and to the swelling of the polymer.

(9) The method for producing a plastic optical device having refractive index profile of any one of (1) to (8), wherein the plastic structure is formed by polymerizing a polymerizable monomer.

(10) The method for producing a plastic optical device having refractive index profile of (9), which comprises polymerizing a first polymerizable monomer to form a plastic structure part having a tubular hollow, and further polymerizing a second polymerizable monomer in the tubular hollow of the plastic structure part to form the plastic structure.

(11) The method for producing a plastic optical device having refractive index profile of any one of (1) to (10), wherein the plastic structure is formed through extrusion molding.

(12) A plastic optical fiber produced according to the production method of any one of (1) to (11).

In the invention, the thermal diffusion at a temperature falling within a specific temperature range has made it possible to provide a refractive index profile much more easily than in an interfacial gel but comparably to the level in the gel.

In addition, the invention has made it possible to produce an optical device having desired refractive index profile, not requiring any complicated step but merely by preparing a hollow tube of high-purity amorphous polymer.

### BRIEF DESCRIPTION OF THE DRAWING

FIG. 1 is a graph showing a refractive index profile of a preform obtained in Example 1 of the invention.

### BEST MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof.

Not specifically defined without overstepping the spirit and the scope of the invention, the plastic for the hollow plastic structure as referred to herein preferably has a refractive index N² of from 1.3 to 1.6. Concretely, it includes methacrylate resin typically such as polymethyl methacrylate (PMMA), polystyrene, polyimide, polycarbonate, silicone resin, and perfluoropolymer such as typically Cytop® and Teflon® AF. More preferably, the invention is applied to polyimide, polycarbonate and perfluoropolymer which could hardly produce a refractive index profile in their formation by polymerization. Also preferably, the degree of polymerization of the plastic structure is from 50 to 300, as the polymer satisfying it can be readily stretched and worked.

Any known method may be employed for preparing the hollow plastic structure. For example, it may be formed of a polymer, or may be formed by polymerizing a monomer. Preferably, it is formed through extrusion molding. For its details, referred to is the description in JP-A 2003-344675.

One concrete example of preparing a hollow plastic structure is described. A first radical-polymerizable compound, a first polymerization initiator and a first chain transfer agent are mixed and polymerized. Preferably, the polymerization is attained with rotating the system. Next, a second radical-polymerizable compound, a second polymerization initiator and a second chain transfer agent are mixed and filled into the hollow of the resulting plastic structure, and polymerized therein. In that manner, an additional plastic structure is formed inside the previously-formed plastic structure to give the intended plastic structure. According to this, the expansion of the hole diameter owing to polymerization shrinkage could be compensated, and therefore this is effective for producing a plastic precursor having any desired hole diameter.

The first radical-polymerizable compound and the second radical-polymerizable compound are, for example, methyl methacrylate (MMA), deuterated methyl methacrylate (MMA-d8), trifluoroethyl methacrylate (3FMA) and benzyl methacrylate (BzMA) as in WO93/08488. Preferred examples of other methacrylate monomers are isopropyl methacrylate (IPMS), t-butyl methacrylate (tBMA), isobornyl methacrylate (IBXMA), norbornyl methacrylate (NBXMA). The first radical-polymerizable compound and the second radical-polymerizable compound may be the same or different. Preferably, however, they are the same in order to make the resulting polymers have a uniform refractive index and to prevent light scattering on the polymers that may have a blend constitution formed therein by mixing different radical-polymerizable compounds.

The first polymerization initiator and the second polymerization initiator are, for example, peroxide compounds such as benzoyl peroxide (BPO), tert-butylperoxy-2-ethylhexanoate (PBO), di-tert-butyl peroxide (PBD), tert-butylperoxyisopropyl carbonate (PBI), n-butyl-4,4-bis(tert-butylperoxy)valerate (PHV). In addition, also preferred are azo compounds such as such as 2,2′-azobisisobutyronitrile, 2,2′-azobis(2-methylbutyronitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate), di-tert-butyl-2,2′-azobis(2-methylpropionate).

Preferably, the first polymerization initiator and the second polymerization initiator are, for example, in a combination that satisfies a relationship of (half-value period temperature of first polymerization initiator)<(half-value period temperature of second polymerization initiator) in order that both the first polymerization reaction and the second polymerization reaction could be uniform.

Preferred examples of the first chain transfer agent and the second chain transfer agent are alkylmercaptans (e.g., n-butylmercaptan, n-pentylmercaptan, n-octylmercaptan, n-laurylmercaptan, tert-dodecylmercaptan), thiophenols (e.g., thiophenol, m-bromothiophenol, p-bromothiophenol, m-toluenethiol, p-toluenethiol). More preferred are alkylmercaptans such as n-octylmercaptan, n-laurylmercaptan, tert-dodecylmercaptan. Also usable herein is a chain transfer agent in which the hydrogen atom of the C—H bond is substituted with a deuterium atom or a fluorine atom. The first polymerization initiator and the second polymerization initiator may be the same or different. Preferably, however, they are the same for the purpose of making the resulting polymers have a uniform molecular weight.

Preferably, the hollow plastic structure as referred to herein is cylindrical.

The cylindrical structure as referred to herein is a three-dimensional shape having a circular cross section. The circle as referred to herein does not always mean a true circle but may include anyone equivalent or similar to it, not overstepping the spirit and the scope of the invention.

Not specifically defined, the non-polymerizable compound (dopant, refractive index control agent) for use in the invention may be any one having a refractive index higher by at least 0.001 than that of the plastic structure.

Preferably, the non-polymerizable compound is as follows: The solubility parameter difference between the compound and the plastic structure is not larger than 7 (cal/cm³)^{1/2} as in Japanese Patent No. 3,332,922 and JP-A 5-173026, and the refractive index difference between the two is at least 0.001 (more preferably at least 0.01 in order that adding a small amount of the compound may produce an effective refractive index difference not causing heat resistance reduction and any excess scattering), and the compound can stably coexist with the plastic structure. Anyone satisfying these is employable herein.

Examples of the compound are described in Japanese Patent No. 3,332,922 and JP-A11-142657, including benzylbenzoate (BEN), diphenyl sulfide (DPS), triphenyl phosphate (TPP), benzyl-n-butyl phthalate (BBP), diphenyl phthalate (DPP), biphenyl (DP), diphenylmethane (DPM), tricresyl phosphate (TCP), diphenyl sulfoxide (DPSO), diphenyl sulfide, bis(trimethylphenyl) sulfide, diphenyl sulfide derivatives, dithiane derivatives, 1,2-dibromotetrafluorobenzene, 1,3-dibromotetrafluorobenzene, 1,4-dibromotetrafluorobenzene, 2-bromotetrafluorobenzotrifluoride, chloropentafluorobenzene, bromopentafluorobenzene, iodopentafluorobenzene, decafluorobenzophenone, perfluoroacetophenone, perfluorobiphenyl, chloroheptafluoronaphthalene, bromoheptafluoronaphthalene. The diphenyl sulfide derivatives and the dithiane derivatives may be suitably selected from the compounds concretely shown below. Above all, preferred for use herein are BEN, DPS, TPP, BBP, DPSO, diphenyl sulfide derivatives and dithiane derivatives; and more preferred are BEN, DPS, TPP, BBP. Compounds derived from the above compounds by substituting the hydrogen atom existing therein with a deuterium atom are also usable herein for the purpose of improving the transparency in a broad wavelength range. In case where a polymerizable compound is used for the refractive index control agent, then the polymerizable monomer is copolymerized with the polymerizable refractive index control agent in forming a matrix. In the case, therefore, it is more difficult to control various characteristics (especially optical characteristics) of the resulting polymers, but there may be a possibility that using such a polymerizable compound may be advantageous in point of the heat resistance of the resulting polymers.

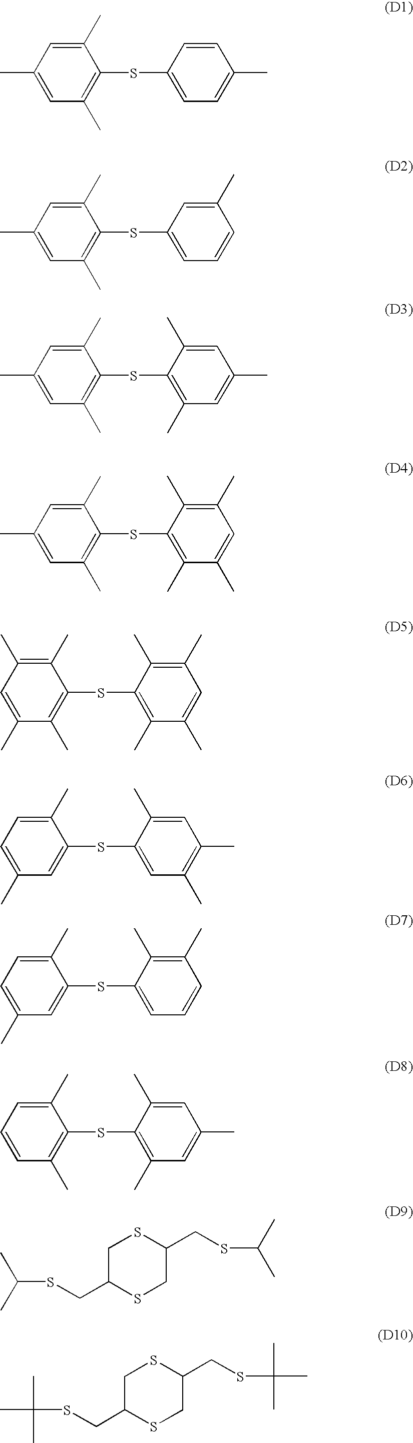

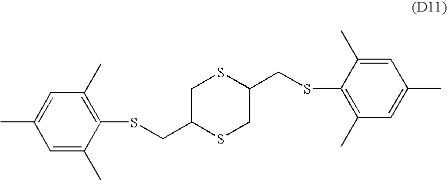

In the invention, the above non-polymerizable compound is filled into the hollow of a hollow plastic structure and this is thermally diffused in the structure. Preferably, the temperature for the thermal diffusion falls within a range that satisfies the following condition relative to the glass transition temperature of the plastic structure,

Tg−35≦Td≦Tg+70, (1)

more preferably,

Tg<Td<Tg+70. (1′)

The thermal diffusion may be attained with rotating the system or keeping the system in a static state.

When it is attained with rotation, then the system is preferably rotated for 24 to 360 hours, more preferably for 48 to 150 hours. The rotation speed is preferably at 10 to 3000 rpm. In particular, when a non-polymerizable compound is filled into a hollow plastic structure to a volume smaller than the capacity of the hollow of the structure, then it is desirable that the system is rotated at a speed of from 1000 to 3000 rpm in order to form a cylindrical hollow inside the structure after the thermal diffusion.

On the other hand, when the thermal diffusion is attained in a static state, it is also desirable that the system is kept static for 24 to 360 hours, more preferably for 48 to 150 hours.

Preferably, the thermal diffusion is attained in an inert gas atmosphere for the purpose of preventing the polymer from being deteriorated under heat. For example, preferred are nitrogen gas, argon gas, helium gas.

In the invention, the non-polymerizable compound is thermally diffused, then brought into contact with the plastic structure and penetrates into it to produce a refractive index profile in the resulting structure. In particular, when the combination of the non-polymerizable compound and the polymer of the hollow plastic structure is such that the non-polymerizable compound may penetrate into the polymer to swell the polymer, then the penetration of the non-polymerizable compound into the swollen polymer may be promoted and, in addition, the compound diffusion may be further promoted relatively in the outward direction since the inner wall of the polymer structure may expand in the center direction owing to the penetration of the non-polymerizable compound into the polymer. Moreover, since the inner wall and therearound of the polymer structure may be kept in contact with a larger amount of the non-polymerizable compound and therefore may be swollen to a higher degree, a larger amount of the non-polymerizable compound may exist in the inner wall and therearound of the polymer structure while the amount of the non-polymerizable compound capable of reaching the outer peripheral part of the polymer structure may decrease, and, accordingly, the non-polymerizable compound diffusion and the polymer swelling may hardly occur in the outer peripheral part thereof. As a result, a refractive index profile may be readily formed in the resulting plastic structure within a short period of time. One example of the combination of the compounds of those types is a combination of a plastic structure generally having a linear constitution or a crosslinked constitution and a colorless transparent, plasticizing function-having non-polymerizable compound capable of improving the workability of plastics and having good compatibility with plastics. Concretely mentioned are combinations of any of polystyrenes, polymethacrylates such as typically polymethyl methacrylate, norbornene resins, polycarbonate resins and their crosslinked derivatives, with any of plasticizers such as phosphates, benzoates, phthalates, sulfides and triazines. Especially preferred is a combination of a transparent plastic structure and a colorless transparent non-polymerizable compound having good solubility with the plastic structure, for example, a combination of polymethacrylate such as polymethyl methacrylate and diphenyl sulfide (DPS) as in the Example of the invention given hereinunder.

In the method of the invention, it is extremely desirable that, after a non-polymerizable compound is filled into the hollow of aplastic structure, then it is continuously subjected to thermal diffusion. Having the constitution, the method has the advantage of preventing uneven penetration of the non-polymerizable compound into the plastic structure, preventing uneven swelling of the plastic structure with the non-polymerizable compound, and preventing cracking of the plastic structure.

In the production method of the invention, it is desirable that the non-polymerizable compound may be liquid at 25° C. Having the constitution, the method is advantageous in that the hollow filling is easy, the compound may be uniformly diffused and the method operability is good.

When a polymerizable compound is filled into the hollow of a plastic structure entirely with no space remaining therein, then the resulting plastic optical device having refractive index profile shall not have a hollow space in its center. The plastic optical device having refractive index profile of the type may be produced, not requiring an additional step of closing the hollow space thereof and not always requiring rotary diffusion, and therefore it is advantageous in that the production cost may be reduced.

On the other hand, when a non-polymerizable compound is filled into the space of a plastic structure to a volume smaller than the capacity of the hollow, then the resulting plastic optical device having refractive index profile shall have a hollow space in the center thereof. In the plastic optical device having refractive index profile of the type, the diffusion concentration of the non-polymerizable compound may be controlled in any desired manner by freely changing the amount of the compound to be applied to the plastic structure, and the optical device of the type is advantageous in that point.

In the production method of the invention, the plastic structure is preferably cylindrical, and the method is preferably employed in producing a plastic optical device having refractive index profile capable of approximating to the following equation (2) in which R indicates the radius of the cross section up to the diffusion interface of the non-polymerizable compound filled in the hollow of the plastic structure, N¹ indicates the refractive index of the non-polymerizable compound before filled in the hollow, N² indicates the refractive index of the plastic structure before filled with the non-polymerizable compound, r indicates a distance from the center of the cross section of the plastic structure filled with the non-polymerizable compound, N(r) indicates the refractive index at the distance r of the plastic structure, and g indicates a refractive index profile coefficient. In case where the plastic structure has a hollow space still remaining therein after filled with a non-polymerizable compound, then the distance r is between the center and the inner wall surface of the corresponding plastic structure with no hollow space therein.

N(r)=N¹(1−(r/R)^{g}×Δ) (2)

wherein Δ=(N¹−N²)/N¹.

The wording “capable of approximating to” as referred to herein means that the actually obtained refractive index profile has a refractive index profile coefficient g with which the coefficient correlation Rc1 to the refractive index profile as approximated in the equation (2) is from 0.95 to 1.0 within a range of 0≦r≦0.9R, and it has a refractive index profile coefficient g with which the coefficient correlation Rc2 to the refractive index profile as approximated in the equation (2) is from 0.9 to 0 within a range of 0≦r≦R.

In the plastic optical device having refractive index profile obtained according to the production method of the invention, it is desirable that the concentration of the non-polymerizable compound in the center of the core after the compound diffusion is from 5 to 25% by weight for preventing the reduction in the heat resistance of POF, and it is also desirable that the compound diffusion distance is from 4 to 10 mm because of the reason that the refractive index profile can be formed in the structure not taking any excessive diffusion time.

In the production method of the invention, the plastic optical device is obtained, for example, as a preform, and this may be stretched to be a plastic optical fiber (POF) for its practical use. According to the production method of the invention, POF having a transmission loss of at most 100 dB/km at 650 nm may be obtained.

For stretching the preform, employable are various stretching methods, for example, as in JP-A07-234322, paragraphs [0007] to [0016]. Accordingly, POF having a desired diameter of, for example, from 200 μm to 1000 μm can be obtained.

In general use thereof, POF is covered with at least one protective layer for the purpose of improving the bending resistance, the weather resistance, the wet deterioration resistance, the tensile strength, the stamping resistance, the flame retardancy, the chemical resistance, the noise resistance to external light and the discoloration resistance to thereby improve the commercial value thereof.

The preform is stretched to give POF, and POF is then worked in a first coating step to give an optical fiber core wire. One or more core wires are, either singly or as combined, further worked in a second coating step to give an optical cable. When the optical cable is a single fiber cable, then it may not be worked in the second coating step, but the single fiber coated with a coating layer in the first coating step may be directly used as an optical cable. There are known two modes of covering the optical cable. One core wire is airtightly covered with a coating material, or the outer surface of a bundle of two or more core wires as combined is airtightly covered with it. This is a contact coating mode. Alternatively, one optical fiber core or a bundle of optical fiber cores are loosely covered with a coating material with a space existing in the interface between them. This is a loose coating mode. In the loose coating mode, when the coating layer is peeled off at the joint part at which the cable is connected with a connector, then water may penetrate into the cable through its cut end and may diffuse in the lengthwise direction of the cable. Therefore, in general, the contact coating mode is preferred.

In the loose coating mode, however, the coating material is not airtightly contacted with the optical fiber core, and therefore, the advantage of this mode is that the coating layer may absorb and relieve much damage such as stress and heat applied to the optical cable. Accordingly, the loose coating mode is preferred in some applications. Regarding the water diffusion through the connector joint part in the loose coating mode, the space in the interface between the optical fiber core and the coating material may be filled with a fluid gel-like semi-solid or granular material, and the water penetration into the joint space may be thereby prevented. Further, when any other function such as heat resistance and mechanical function improvement is imparted to the semi-solid or granular material, then the optical fiber cable thus produced may have a multi-functional coating layer. The loose coating may be attained by controlling the extrusion nipple position at the crosshead die and controlling the degree of pressure reduction by the degassing device used, whereby the layer having the above-mentioned space may be formed around the core cable. The thickness of the space layer may be controlled by controlling the nipple thickness and the degree of pressure application/pressure reduction in the space layer.

The coating layer to be formed in the first coating step and the second coating step may contain a flame retardant, an UV absorbent and an antioxidant added thereto not having any negative influence on the light transmittability of the coated cable.

The flame retardant may be any of halogen-containing, for example, bromine-containing resins or additives, and phosphorus-containing compounds. However, from the viewpoint of the safety for reducing toxic gas in firing, the mainstream of the f lame retardant is being a metal hydroxide such as aluminium hydroxide or magnesium hydroxide. The metal hydroxide contains water as its internal crystal water therein. The water results from the water adhesion to the metal hydroxide during its production process, and completely removing it may be impossible. Accordingly, the flame retardation by the use of such a metal hydroxide is preferably attained by adding it to the outermost coating layer of the cable but not adding it to the coating layer that is in direct contact with POF.

For imparting any other different functions to the optical cable, any additional functional coating layers may be suitably laminated at any desired position. For example, in addition to the above-mentioned flame-retardant layer, a barrier layer for inhibiting moisture absorption of POF and a moisture-absorbing material layer for removing moisture from POF may be formed. For forming such a moisture-absorbing material layer, for example, a moisture-absorbing tape or a moisture-absorbing gel may be formed inside a predetermined coating layer or between coating layers. The other functional layers are, for example, a flexible material layer for stress relaxation when the cable is bent, a foam material layer serving as a buffer for external stress relaxation, and a reinforcing layer for increasing the toughness of the cable. Except resin, any other structural material may be used for constituting the optical cable. For example, thermoplastic resin that contains high-elasticity fibers (high-strength fibers) and/or wires such as high-rigidity metal wires are preferably used for reinforcing the mechanical strength of the optical cable.

The high-strength fibers are, for example, aramid fibers, polyester fibers, polyamide fibers. The metal wires are, for example, stainless wires, zinc alloy wires, copper wires. However, these are not limitative. In addition, an outer metal tube sheathing for cable protection, a supporting wire for overhead cable construction, and any other mechanism for improving wiring operation may be inserted into the outer periphery of the optical cable.

The optical cable may have any desired shape, depending on its use. For example, a bundle cable formed by concentrically bundling optical fiber cores, a tape cable formed by aligning them in lines, a covered cable formed by covering them with a presser coat or a wrapping sheath may be employed depending on the use of the optical cable.

As compared with an ordinary optical cable, the optical cable obtained from POF of the invention has a broader latitude in axis shifting, and therefore, it may be butt-jointed. Preferably, however, an optical connector for joint is disposed at the end of the optical cable, and the cables are surely fixed and connected via the optical connector therebetween. The connector may be any known, commercially-available one, such as PN connectors, SMA connectors, SMI connectors.

The optical cable obtained from POF of the invention is used, favorably as combined with an optical signal processor that comprises various optical members such as light emitter, light receiver, light switch, optical isolator, optical integrated circuit, optical transmit-receive module. In this case, the optical fiber of the invention may be combined with any other optical fibers, and any known techniques relating to it may be employed. For example, reference may be made to Base and Practice of Plastic Optical Fibers (issued by NTS); and Nikkei Electronics Dec. 3, 2001, pp. 110-127 “Optical device Mounted on Printed-Wiring Board, Now or Never”. Combined with various techniques disclosed in these references, the invention may be favorably applied to light-transmission systems suitable to short-range appliances for high-speed large-capacity data communication and control with no influence of electromagnetic waves thereon, typically for example, in-unit wiring for computers and various digital instruments, in-unit wiring for vehicles and ships, optical linking for optical terminals to digital devices or digital devices to each other, and indoor or in-area optical LAN for houses, apartments, factories, offices, hospitals, schools.

Further, as combined with any of those described in IEICE TRANS. ELECTRON., Vol. E84-C, No. 3, March 2001, pp. 339-344, “High-Uniformity Star Coupler Using Diffused Light Transmission”, and Journal of Electronics Packaging Society, Vol. 3, No. 6, 2000, pp. 476-480 “Interconnection by Optical Sheet Bus Technique”; disposition of light-emitting device relative to optical waveguide face, as described in JP-A 2003-152284; optical busses described in JP-A 10-123350, 2002-90571, 2001-290055; optical branching/coupling devices described in JP-A 2001-74971, 2000-329962, 2001-74966, 2001-74968, 2001-318263, 2001-311840; optical star couplers described in JP-A 2000-241655; optical signal transmission devices and optical data bus systems described in JP-A2002-62457, 2002-101044, 2001-305395; optical signal processors described in JP-A 2002-23011; optical signal cross-connection systems described in JP-A 2001-86537; light transmission systems described in JP-A 2002-26815; multi-function systems described in JP-A2001-339554, 2001-339555; and also other various optical waveguides, optical branching filters, optical connectors, optical couplers, optical distributors, the invention may construct higher-level optical transmission systems for multi-transmit-receive communication. Apart from the above-mentioned light-transmission applications, the invention is also applicable to any other fields of lighting (light conduction), energy transmission, illumination, and sensors.

The invention is described in more detail with reference to the following Examples, in which the material used, its amount and ratio, the details of the treatment and the treatment process may be suitably modified or changed not overstepping the spirit and the scope of the invention. Accordingly, the invention should not be limitatively interpreted by the Examples mentioned below.

### EXAMPLE 1

### Formation of Hollow PMMA Structure

A mixture of MMA as a radical-polymerizable compound, 2,4-dimethylvaleronitrile (W-65, trade name by Wako Jun-yaku) as a polymerization initiator and n-laurylmercaptan as a chain transfer agent was injected into a glass tube having an outer diameter of 21.5 mm, an inner diameter of 18.5 mm and a length of 40 cm. 2,4-dimethylvaleronitrile dried to have a water content of at most 200 ppm was used herein. The blend ratio of 2,4-dimethylvaleronitrile and n-laurylmercaptan to MMA was 0.04 mol % and 0.4% by mass, respectively. Next, the glass tube was set in the body of a polymerization reactor of a rotary polymerization device with its lengthwise direction kept horizontal therein, and this was subjected to thermal polymerization at 80° C. for 2 hours with rotating at 2000 rpm. A mixture of the radical-polymerizable compound MMA, a polymerization initiator dimethyl 2,2-azobis(isobutyrate) (MAIB, trade name by Wako Jun-yaku) and the chain transfer agent n-laurylmercaptan was injected into the hollow tube of PMMA thus formed herein. The blend ratio of dimethyl 2,2-azobis(isobutyrate) and n-laurylmercaptan to MMA was 0.01 mol % and 0.4% by mass, respectively. The hollow tube of PMMA with the starting materials therein was set in the polymerization reactor body of a rotary polymerization device 41 with its lengthwise direction kept horizontal therein, and this was subjected to thermal polymerization at 70° C. for 10 hours with rotating at 2000 rpm. Finally, a hollow tube of PMMA having an outer diameter of 18.5 mm and an inner diameter of 5 mm was obtained.

### Filling and Thermal Diffusion of Diphenyl Sulfide:

Diphenyl sulfide that had been filtered under reduced pressure through a 0.1-μm PTFE membrane filter was put into the PMMA hollow tube. Next, kept horizontally, this was rotated at 120° C., higher by 15° C. than Tg, 105° C. of PMMA, for 143 hours at 2000 rpm. The refractive index of diphenyl sulfide is 1.63, and the refractive index of PMMA is 1.49.

### Determination of Refractive Index Profile of Preform:

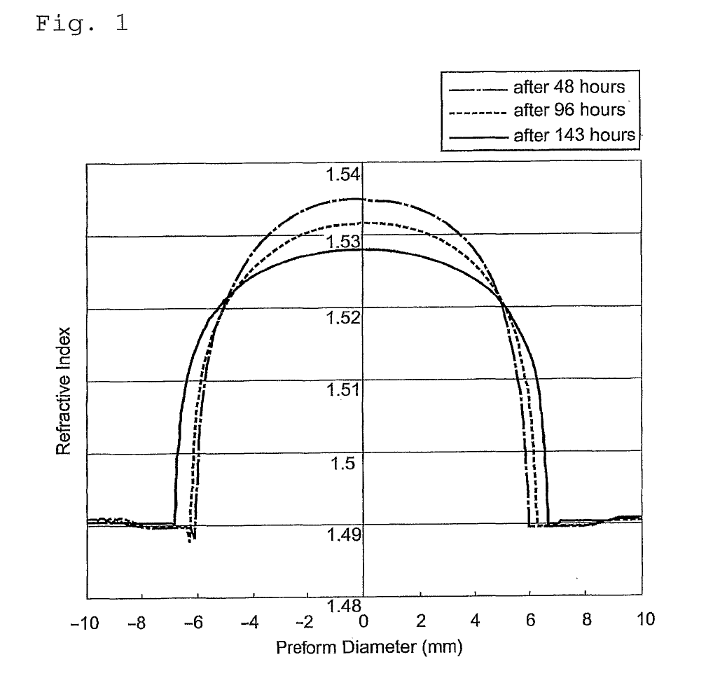

Using a preform analyzer (IP5000 by Seiko EG & G), the preform obtained herein was analyzed for the refractive index profile thereof at different diffusion times. The results are shown in FIG. 1. The refractive index profile data of the preform that had been subjected to thermal diffusion for 143 hours were applied to the equation (2). The refractive index profile coefficient g is 3.15; the correlation coefficient rc1 is 0.99; Rc2 is 0.95. The data confirm that the preform obtained according to the above-mentioned method has a refractive index profile not overstepping the equation.

### Determination of Transmission Loss of POF:

The preform obtained herein was stretched to give POF having an outer diameter of 500 μm. Its transmission loss was 150 dB/km at 650 nm.

### Determination of Transmission Zone of POF:

The transmission zone of the POF having an outer diameter of 500 μm obtained herein was 1 GHz/100 m.

### EXAMPLE 2

The same process as in Example 1 was repeated, except that PMMA was formed into a hollow tube in a mode of extrusion molding. As a result, a good preform and a good POF like in Example 1 were obtained.

### EXAMPLE 3

The same process as in Example 1 was repeated, except for the following points: A norbornene-based heat-resistant polymer (Arton polymer), which could not be formed into a hollow tube through direct polymerization of monomer, was formed into a hollow tube in a mode of extrusion molding, and the thermal diffusion was carried out at 200° C., higher by 40° C. than Tg (160° C.) of Arton. The transmission loss of POF produced by stretching the preform obtained herein was 500 dB/km at 650 nm, and the transmission zone thereof was 1.5 GHz/100 m.

1. A method for producing a plastic optical device having refractive index profile, which comprises filling the hollow of a hollow plastic structure with at least one non-polymerizable compound having a refractive index higher by at least 0.001 than that of the plastic structure, and diffusing the non-polymerizable compound into the plastic structure.

2. The method for producing a plastic optical device having refractive index profile of claim 1, wherein the refractive index of the non-polymerizable compound is higher by at least 0.01 than that of the plastic structure.

3. The method for producing a plastic optical device having refractive index profile of claim 1, wherein the non-polymerizable compound is thermally diffused within a temperature range (Td) satisfying the condition of the following equation (1) relative to the glass transition temperature (Tg) of the plastic structure:
Tg−35≦Td≦Tg+70. (1)

4. The method for producing a plastic optical device having refractive index profile of claim 1, wherein the non-polymerizable compound is thermally diffused within a temperature range (Td) satisfying the condition of the following equation (1) relative to the glass transition temperature (Tg) of the plastic structure:
Tg<Td<Tg+70. (1)

5. The method for producing a plastic optical device having refractive index profile of claim 1, wherein the diffusion is attained with rotating the plastic structure.

6. The method for producing a plastic optical device having refractive index profile of claim 5, wherein the rotation speed is from 1000 to 3000 rpm.

7. The method for producing a plastic optical device having refractive index profile of claim 1, wherein the diffusion is attained with keeping the plastic structure vertical in a static state.

8. The method for producing a plastic optical device having refractive index profile of claim 1, wherein the plastic structure is cylindrical, and the plastic optical device having refractive index profile approximates to the following equation (2) in which R indicates the radius of the cross section up to the diffusion interface of the non-polymerizable compound filled in the hollow of the plastic structure, N¹ indicates the refractive index of the non-polymerizable compound before diffusion, N² indicates the refractive index of the plastic structure before filled with the non-polymerizable compound, N(r) indicates the refractive index at a distance r from the center of the cross section of the plastic structure after filled with the non-polymerizable compound, and g indicates a refractive index profile coefficient:
N(r)=N¹(1−(r/R)^{g}×Δ) (2)
wherein Δ=(N¹−N²)/N¹.

9. The method for producing a plastic optical device having refractive index profile of claim 1, wherein the non-polymerizable compound is selected from a group consisting of benzyl benzoate (BEN), diphenyl sulfide (DPS), triphenyl phosphate (TPP), benzyl-n-butyl phthalate (BBP), diphenyl phthalate (DPP), biphenyl (DP), diphenylmethane (DPM), tricresyl phosphate (TCP), diphenyl sulfoxide (DPSO), diphenyl sulfide, bis(trimethylphenyl) sulfide, diphenyl sulfide derivatives, dithiane derivatives, 1,2-dibromotetrafluorobenzene, 1,3-dibromotetrafluorobenzene, 1,4-dibromotetrafluorobenzene, 2-bromotetrafluorobenzotrifluoride, chloropentafluorobenzene, bromopentafluorobenzene, iodopentafluorobenzene, decafluorobenzophenone, perfluoroacetophenone, perfluorobiphenyl, chloroheptafluoronaphthalene and bromoheptafluoronaphthalene.

10. The method for producing a plastic optical device having refractive index profile of claim 9, wherein the non-polymerizable compound is selected from a group consisting of BEN, DPS, TPP, BBP, DPSO, diphenyl sulfide derivatives and dithiane derivatives.

11. The method for producing a plastic optical device having refractive index profile of claim 1, wherein the non-polymerizable compound is liquid or solid at 25° C. and the non-polymerizable compound is filled into the hollow to a volume smaller than the capacity of the hollow.

12. The method for producing a plastic optical device having refractive index profile of claim 1, wherein the non-polymerizable compound is liquid at 25° C.

13. The method for producing a plastic optical device having refractive index profile of claim 12, wherein the non-polymerizable compound is filled into the hollow entirely with no space remaining therein.

14. The method for producing a plastic optical device having refractive index profile of claim 1, wherein the plastic structure is a polymer that swells through penetration of the non-polymerizable compound thereinto, and the non-polymerizable compound is diffused owing to the penetration of the compound and to the swelling of the polymer.

15. The method for producing a plastic optical device having refractive index profile of claim 1, wherein the refractive index of the plastic structure is from 1.3 to 1.6.

16. The method for producing a plastic optical device having refractive index profile of claim 1, wherein the plastic structure is formed by polymerizing a polymerizable monomer.

17. The method for producing a plastic optical device having refractive index profile of claim 16, wherein the degree of polymerization of the plastic structure is from 50 to 300.

18. The method for producing a plastic optical device having refractive index profile of claim 16, which comprises polymerizing a first polymerizable monomer to form a plastic structure part having a tubular hollow, and further polymerizing a second polymerizable monomer in the tubular hollow of the plastic structure part to form the plastic structure.

19. The method for producing a plastic optical device having refractive index profile of claim 1, wherein the plastic structure is formed through extrusion molding.

20. A plastic optical fiber produced according to the production method of claim 1.
